(19) United States
(12) Patent Application Publication
(10) Pub. No.: US 2015/0089062 A1
(43) Pub. Date: Mar. 26, 2015

(54) METHODS AND SYSTEMS FOR DYNAMICALLY SPECIALIZING AND RE-PURPOSING COMPUTER SERVERS IN AN ELASTICALLY SCALING CLOUD COMPUTING INFRASTRUCTURE

(71) Applicant: LEONARDO REITER, AUSTIN, TX (US)

(72) Inventor: LEONARDO REITER, AUSTIN, TX (US)

(73) Assignee: VIRTUAL BRIDGES, INC., AUSTIN, TX (US)

(21) Appl. No.: 14/036,845

(22) Filed: Sep. 25, 2013

(51) Int. Cl. H04L 12/911

(52) U.S. Cl. CPC H04L 47/70
USPC 709/226

(57) ABSTRACT

Methods and systems for dynamically repurposing and elastically scaling cloud computing networks and infrastructures in response to user workload requirements. The system receives, via a network interface, a workload request to manage a workload, determines workload requirements, and assigns the workload to an appropriate server in a server resource pool. Server capabilities and the server resource pool can be dynamically modified to satisfy current or expected workload requirements. An isolated gateway is provided such that data to and from the cloud computing network is physically segregated, thus providing data security. The cloud computing network is structured to provide multi-level security for workloads and workload owners.

### FIELD OF THE INVENTION

The present disclosure relates to the field of systems and methods for cloud computing data and workload management. In particular, the disclosed subject matter relates to methods and systems for dynamically repurposing and elastically scaling cloud computing networks and infrastructures in response to user workload requirements.

### BACKGROUND OF THE INVENTION

Traditional cloud computing networks can be split into categories based on the method in which they are deployed. The two main categories of cloud computing networks are public cloud computing networks and private cloud computing networks.

A public cloud computing network can host or process data for a large number of users. This can be beneficial for sharing resources to achieve economies of scale and for maximizing the effectiveness of those shared resources. In addition, public cloud computing networks offer relatively easy scaling options. This is particularly useful when the server workload varies over a large range or is unpredictable. However, public cloud resources are usually shared by multiple, unrelated users. The processing of information from multiple users has led to security concerns, especially when sensitive information is involved.

A private cloud computing network, on the other hand, can be segregated so that user's data and processing are deployed on a physically separate network from that of other users. Private cloud computing networks can be deployed on a user's premises in order to ensure physical data separation. This method of cloud computing often does not involve the same data security risks associated with public cloud computing networks. Private cloud computing networks, however, are more expensive to set up and utilize than public cloud computing networks. Furthermore, private cloud computing networks are more laborious to scale up than their public cloud counterpart.

In order to maximize scalability and minimize costs, hybrid clouds have been developed. For example, a user with a private cloud computing network might utilize on-premises resources during average workloads, and use public cloud resources during spikes in processing demands. While this solves the scalability problems involved with private cloud computing networks, it does not solve the security concerns associated with traditional public cloud computing networks.

### SUMMARY

Embodiments of the presently disclosed subject matter provide methods and systems for dynamically repurposing and elastically scaling cloud computing networks and infrastructures in response to user workload requirements. In accordance with the embodiments, cloud computing infrastructures are provided that respond at least in part to the foregoing issues and/or other issues.

In one embodiment, the presently disclosed subject matter (hereinafter “system”) receives from a computer and/or server, via a network interface, a workload request to manage a workload in a cloud computing infrastructure. The workload can have one or more workload requirements. The system then determines what the workload requirements associated with the workload request are. In order to facilitate the workload request, the system evaluates a server resource pool and/or a computer resource pool (hereinafter “Resources”) in order to determine which of the two or more Resources can satisfy the workload requirements of the workload request. The system then determines, from the remaining Resources in the Resource pool, which Resource is the best fit for the workload request. The system assigns the workload to the Resource identified as the best fit for the workload request.

The system can allow each Resource in the cloud computing infrastructure to independently and automatically advertise one or more capabilities associated with said Resource in order to simplify the process of determining which Resources in the Resource pool can satisfy the workload requirements of the workload request. In some embodiments, the system can allow a user with appropriate credentials, such as a network administrator, to explicitly and dynamically add or remove one or more capabilities associated with any of the Resource in the cloud computing infrastructure. In addition, the system can allow the addition, modification, and/or deletion of one or more capabilities of one or more of the Resources in the Resource pool without requiring the Resource to be shut down. In various embodiments, the system can include an isolated gateway such that one or more individual workloads are physically separated from other workloads being managed in a single cloud computing network. In further embodiments, the system can allow the creation and nesting of workload requirement zones. In some embodiments, the system can be configured such that the user does not have explicit knowledge of the particular Resource that is handling the user's workload, how the workload requirement zones are arranged and utilized, and/or the topology of the cloud computing network.

### BRIEF DESCRIPTIONS OF THE DRAWINGS

Various novel and non-obvious features believed characteristic of the disclosed subject matter are set forth in the claims. The disclosed subject matter itself, however, as well as modes of use, further objectives, and advantages thereof, will best be understood by reference to the following detailed description of illustrative embodiments when read in conjunction with the accompanying drawings, wherein:

FIG. 1 depicts one embodiment of a traditional cloud computing network's “zone” configuration (prior art).

FIG. 2 depicts the method in which workload “resource tags” are matched with Resource's “advertised capabilities.”

FIG. 3 depicts one embodiment of the method in which the system evaluates a workload request and assigns said workload to a Resource.

FIG. 4a depicts one embodiment of the method in which a plurality of Resources in a cloud computing network can advertise a plurality of capabilities that said Resource(s) possess.

FIG. 4b depicts one embodiment of the method in which Resources and Resource capabilities in a cloud computing network can be nested within one another based on said Resource's advertised server capabilities.

FIG. 5 depicts one embodiment of the system and method by which a private cloud computing network can be implemented via a public cloud network. FIG. 5 includes an isolated gateway implemented to facilitate the physical segregation of one or more workload owner's data from data belonging to other workload owners.

In the FIGURES, like elements should be understood to represent like elements, even though reference labels are omitted in some instances of a repeated element, for simplicity.

### DETAILED DESCRIPTION OF ILLUSTRATIVE EMBODIMENTS

Reference is now made to the drawings, in which the same reference numbers are used throughout the different figures to designate the same components.

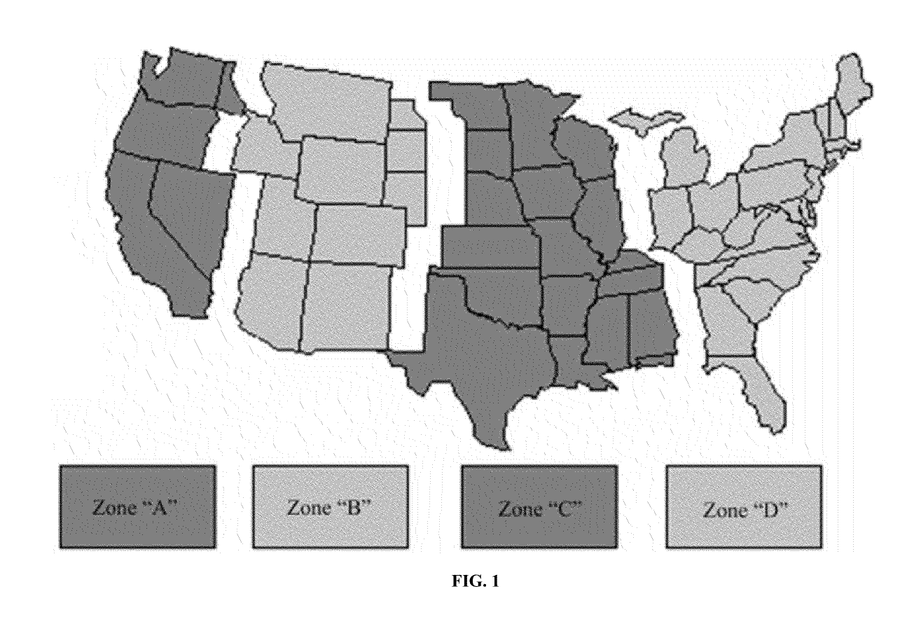

FIG. 1 depicts one method in which a traditional public cloud computing network can be segregated into “zones” based on the geographic location of each individual server. A server is only accessible to workloads which are geographically located in the same region or “zone” as the server. For example, a user in California would have access to workload zone “A” 100. Similarly, a user might be in New Mexico and use Zone “B” 102, Texas and use Zone “C” 104, or New York and use Zone “D” 106.

In other embodiments, cloud computing network zones can be a pool of servers and/or a plurality of computing resources that are isolated from others to achieve a particular task or a set of computers and/or devices that users can be granted access to.

The public cloud computing networks achieve a more balanced workload across servers by implementing such a method of workload segregation. The zones in the traditional public cloud computing network are generally created within the infrastructure at the time the network is created. A zone can be created based on a plurality of criteria including geographic location, type of computing requirements, etc. The zone that a workload will operate within must be explicitly selected by the user, a broker, etc. prior to using the public cloud computing resource. This ensures that the workload is handled in the appropriate zone. This also creates a problem, however, as a user might have to log in and out of cloud networks based on the changing type of computing resource the client/user is using at a particular time. In addition, workload backlogs can occur in servers or zones in which a high volume of workloads are handled by a particular server.

In contrast, in the disclosed subject matter, zones have been replaced by “resource tags.” Resource tags can be used to access network capabilities and/or to require capabilities.

In one embodiment, the resource tags may be based on dynamic zoning. The cloud computing network can determine the requirements based on a plurality of workloads that said cloud computing network is managing. In this way, the cloud computing network can determine which of the available Resources are capable of handling the workload requirements by matching the workload requirements with the advertised capabilities of Resources in the cloud computing network. The cloud computing network then assigns the workload to a Resource that is least busy and capable of handling the workload requirements of the workload.

In other embodiments, as the needs of a particular workload change, the system can adjust Resources in the cloud computing network by adding, removing, and/or modifying Resources and/or said Resource's capabilities.

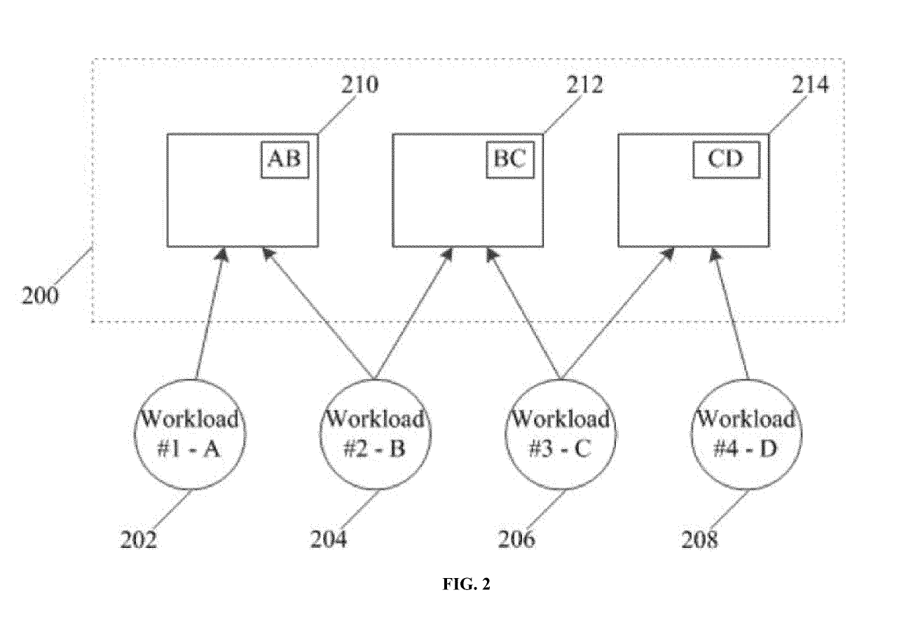

FIG. 2 depicts one embodiment of the method in which workload “resource tags” are matched with the advertised capabilities of a given Resource. In various embodiments, a virtual “broker” may determine the computing requirements of the workload and assign that workload to a Resource with advertised capabilities that meet the workload's requirements. A cloud computing network 200 might, for example, have Resources 210, 212, and 214 with advertised capabilities “A” and “B;” “B” and “C;” and “C” and “D,” respectively. When the cloud computing network 200 receives a workload request with associated workload requirements, said workload is assigned to a particular Resource based on the system's determination of the best fit Resource for said workload. Workload 202 has workload requirement “A.” The system, upon receiving a workload request from workload 202, will determine the best fit for workload 202 is, in this example, Resource 210. Workload 204 has workload requirement “B.” Upon receiving a workload request from workload 204, the system will determine the best fit Resource for said workload. In this example, both Resources 210 and 212 have the necessary advertised capability, namely “B.” The system will determine which of the Resources with the necessary advertised capabilities is the best fit for workload 204 and then assign the workload to the best fit Resource. Similarly, workload 206 has workload requirement “C.” Resources 212 and 214 both have the necessary advertised capability, and thus the system will determine which of the Resources is the best fit for workload 206 and assign workload 206 to the best fit Resource. Workload 208 has workload requirement “D.” Upon receiving a workload request from workload 208, the system will determine that best fit Resource for said workload is Resource 214 as that is the only Resource with advertised capability “D.”

In various embodiments, a broker can be utilized in assigning a workload requests to a Resource in the cloud computing network 200. In other embodiments, criteria such as the current workload of each Resource, advertised capabilities in addition to those required for a given workload request, etc. can be employed to determine the Resource that is the best fit for a particular workload request.

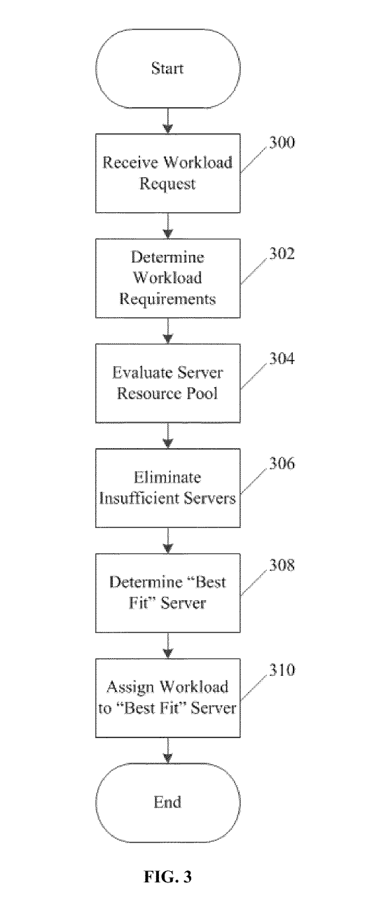

FIG. 3 depicts one embodiment of the method in which the system evaluates a workload request and assigns the workload to a Resource. Upon receiving a workload request at reference 300, the system determines the workload requirements of the workload 302. The system then evaluates the Resource pool to determine the capabilities available in the Resource pool 304. In some embodiments, the system can periodically evaluate the Resource pool irrespective of whether a workload request has been received and store data related to the available Resources such that the process of reference 304 is made more efficient. In other embodiments, the system can store information related to which Resources are available and the capabilities of each Resource, as well as maintaining the information and frequently updating the information. After determining the workload requirements of a workload request 302 and evaluating the capabilities of Resources in the cloud computing network 304, the system eliminates any of the Resources in the cloud computing network that do not have sufficient capabilities to manage the workload request from consideration 306. The system then determines which of the remaining Resources is most capable of managing the workload request 308. In some embodiments, the system can determine a best fit for a particular workload based on current Resource workloads. In other embodiments, the system can determine the best fit for a workload by considering a plurality of criteria such as each Resource's advertised capabilities, the number of available, but unnecessary for a particular workload, Resource capabilities, average workload of each Resource, the number of Resources with alternate capabilities, etc. After determining which Resource is the best fit for a particular workload, the system assigns said workload to the Resource 310.

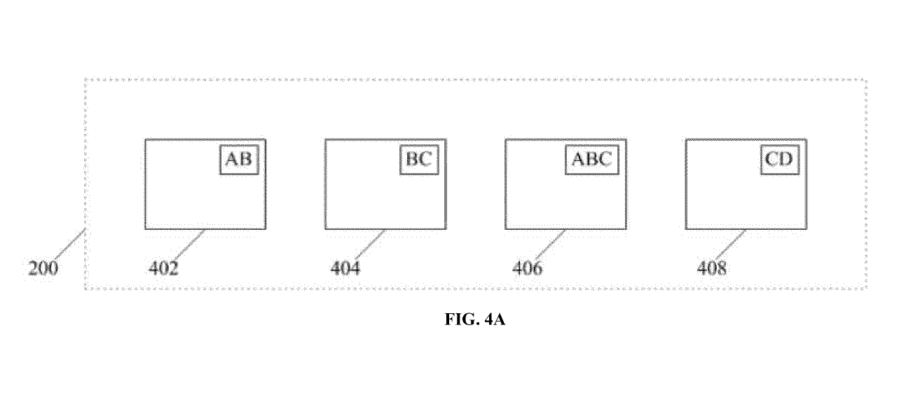

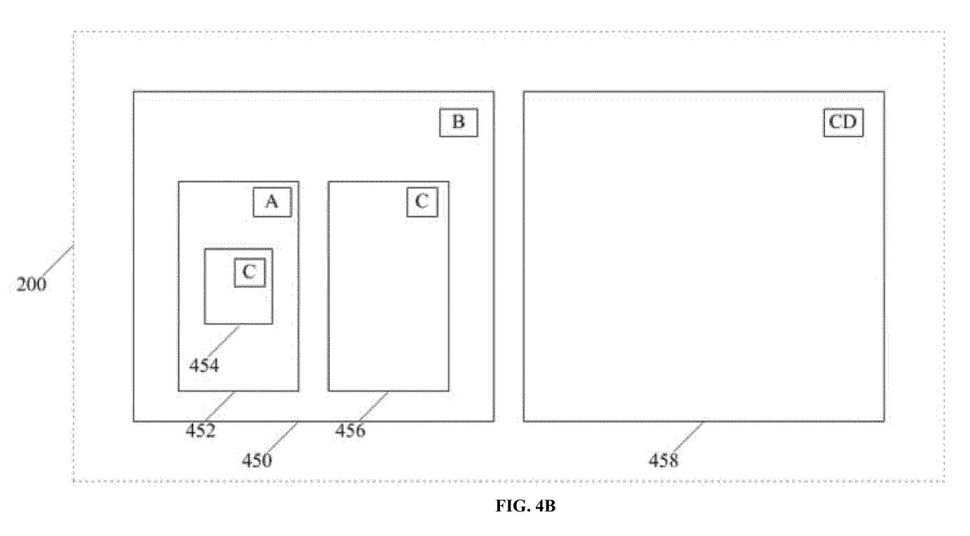

FIG. 4a depicts one embodiment of the method in which a plurality of Resources in a cloud computing network 200 can advertise their respective capabilities. In this illustrative embodiment, the system acknowledges that Resource 402 has capabilities “A” and “B.” Similarly, the system acknowledges that Resources 404, 406, and 408 have capabilities “B” and “C”; “A,” “B,” and “C”; and “C” and “D,” respectively. In some embodiments, the advertised capabilities can be controlled by the Resources themselves. In other embodiments, an individual with appropriate credentials, such as a network administrator, can manually add, remove, and/or modify the advertised capabilities.

Further understanding of the workload requests and workload requirements may be obtained through examples. If a workload request is received by the cloud computing network, the presently disclosed subject matter will assign the workload request to a Resource in the cloud computing network that is found to be the best fit for the workload request. For example, if a workload request is received that requires workload requirement “B,” one of the Resources in the cloud computing network that has advertised capability “B” will be assigned the workload.

In some embodiments, the best fit Resource can be determined by evaluating the existing workloads of the Resources and assigning the workload request to the Resource with the lowest existing workload at that time. For example, a cloud computing network could exist in which there are three Resources. Resource 1 has advertised capability “A” and is currently managing one workload request. Resource 2 has advertised capability “B” and is currently managing five workload requests. Resource 3 has advertised capabilities “A” and “B” and is currently not managing any workload requests. If a workload request is received with workload requirement “B,” the workload request would be assigned to Resource 3 because Resource 3 had the lowest existing workload at the time the workload request was received and Resource 3 has advertised capability “B.”

In other embodiments, the best fit Resource can be determined by matching the workload requirements of the workload request with a Resource that has the fewest advertised capabilities in addition to those that are required by the workload request. Using the cloud computing network from Paragraph 27 (above), if a workload request is received with a workload requirement “B,” the workload request would be assigned to Resource 2 because Resource 2 has the advertised capability “B” and no further advertised capabilities.

In further embodiments, a plurality of metrics, including those discussed above, can be used to determine which Resource in a cloud computing network is the best fit for a particular workload request.

FIG. 4b depicts one embodiment of the method in which Resources and Resource capabilities in a cloud computing network 200 can be nested within one another based on the Resource's advertised capabilities. In this illustrative embodiment, the Resources in the cloud computing network 200 are nested within one another based on the advertised capabilities. The cloud computing network 200 contains an advertised capability “B” 450. Within advertised capability “B” 450 are two independent capabilities: “A” 452 and “C” 456. Thus, the Resource represented by 452 has the capabilities of the group it represents as well as the group it is nested within (i.e. “A” and “B”). Further, the Resource represented by 454 has the advertised capability of “C,” and is nested within 452. Thus, the Resource represented by 454 has capabilities “A,” “B,” and “C.” Similarly, Resource 456 has the advertised capability “C” as well as that of the group it is nested within, “B.” Thus, the Resource represented by 456 has capabilities “B” and “C.” Further still, the Resource represented by 458 has the advertised capabilities “C” and “D,” but is not nested within another advertised capability and therefore is not considered to possess additional capabilities.

The ability to nest Resources within one another is particularly useful for implementing multi-level security over a public cloud computing network. For example, a public cloud computing network might provide Resources for Company X. Company X might have three distinct groups of employees, each of which have unique workload requirements. A Company X Resource could be located in the public cloud computing network, and Company X credentials might be required in order to access the Company X Resource. Nested within the Company X Resource might be one Resource for engineering, one Resource for accounting, and one Resource for marketing. Each of the nested Resources might have unique advertised capabilities, and each of the nested Resources can require additional, unique credentials in order to access the Resource.

Furthermore, the ability to nest Resources allows multiple levels of nesting. For example, nested within the engineering Resource for Company X from Paragraph 31 might be one Resource for high-performance three dimensional simulations and another Resource for high-speed data acquisition and manipulation. Just as before, the Resources nested within the engineering Resource can require additional, unique credentials in order to access the Resource.

In addition to the security benefits of nested Resources, compliance with Federal regulations such as HIPAA, SEC regulations, and other relevant laws and guidelines is facilitated through the use of nested Resources.

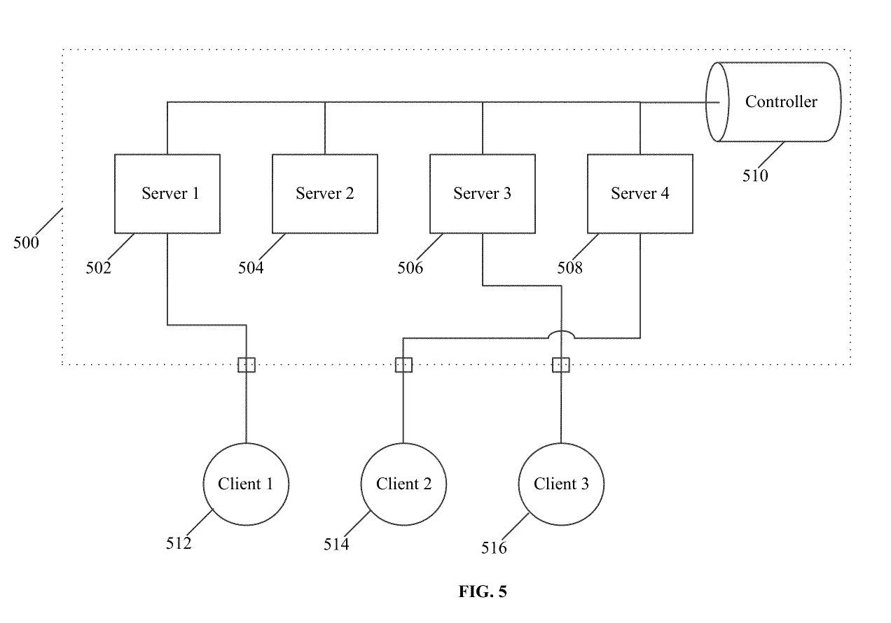

FIG. 5 depicts one embodiment of the method and system by which private cloud networks can be implemented via a public cloud computing network. In various embodiments, the public cloud computing network 500 contains a plurality of Resources. Those Resources, for example, could be Resource 1 (502), Resource 2 (504), Resource 3 (506), and Resource 4 (508). In addition, a plurality of clients with workloads can exist outside of the cloud computing network 500. The plurality of clients could be, for example, client 1 (512), client 2 (514), and client 3 (516). The aforementioned plurality of Resources can have a plurality of advertised capabilities. Each of the plurality of Resources in the cloud computing network share a back-end control signal that is controlled by a controller 510. When a client connects to the cloud computing network 500, the client is connected to any one of the plurality of Resources that has sufficient capabilities to handle the client's workload. It is worth noting that in one embodiment, the controller 510, and by extension the connection between the controller 510 and any Resource, does not receive any of the data contained in the workload or otherwise transmitted to or from a client. Instead, the controller merely acts as a means for communication among the Resources in the cloud computing network.

In various embodiments of the presently disclosed subject matter, the cloud computing networks are segregated into zones based on the workload(s) and/or workload requirements, and the groups of cloud computing networks can be dynamically modified to meet the unique requirements of existing workloads as those requirements change. Among other items, dynamically includes reassigning the capabilities of one or more Resources without needing to reboot the Resource.

What is claimed is:

1. A method comprising:
receiving from a computer via a network interface a workload request to manage a workload in a cloud computing infrastructure, wherein the workload has at least one workload requirement;
determining the one or more workload requirements associated with the workload request;
evaluating a server resource pool with at least two servers in the cloud computing infrastructure to determine which of the at least two servers in said server resource pool can satisfy the at least one workload requirement of the workload request wherein each of the at least two servers in said server resource pool have at least one capability;
eliminating any of said at least two servers from the server resource pool that cannot satisfy at least one of the at least one workload requirement of the workload request by comparing the at least one workload requirement and the at least one capability of each of the at least two servers;
determining which of the at least two servers, from the remaining servers in the server resource pool, is the best fit for the workload request based on:
the existing workload of each server; and
other related criteria; and
assigning the workload to the server determined as the best fit for the workload request.

2. The method of claim 1 further comprising allowing each server in the cloud computing infrastructure to independently and automatically advertise one or more capabilities associated with said server.

3. The method of claim 1 further comprising allowing at least one user with appropriate permission to explicitly add or remove one or more capabilities associated with any of the servers in the cloud computing infrastructure.

4. The method of claim 1 further comprising enabling at least one of adding, modifying, or deleting one or more capabilities of one or more servers in the server resource pool such that one or more capabilities of the server in the cloud computing infrastructure can be modified.

5. The method of claim 1 further comprising providing an isolated gateway in which the workload is physically separated from other workloads being managed in a single cloud computing network infrastructure.

6. The method of claim 1 further comprising enabling the creation of a first workload requirement zone nested within a second workload requirement zone such that the first nested workload requirement zone includes the requirements of the first nested workload requirement zone and the requirements of the second workload requirement zone in which it is nested.

7. The method of claim 1 wherein (dependent claim about hiding which server is actually doing the work or that the network structure and how the system handles a workload is transparent).
